(19) United States
(12) Patent Application Publication
(10) Pub. No.: US 2018/0141369 A1
(43) Pub. Date: May 24, 2018

(54) IMPROVEMENTS IN SECURITY SUBSTRATES

(71) Applicant: De La Rue International Limited, Hampshire (GB)

(72) Inventor: Robert WHITEMAN, Berkshire (GB)

(73) Assignee: De La Rue International Limited, Hampshire (GB)

(21) Appl. No.: 15/568,623

(22) PCT Filed: Apr. 4, 2016
(86) PCT No.: PCT/GB2016/050953

§ 371 Date: Oct. 23, 2017

(30) Foreign Application Priority Data
Apr. 24, 2015 (GB) 1506990.9

(51) Int. Cl. B42D 25/333; B42D 25/45; B42D 25/346; B42D 25/29; B42D 25/351

(52) U.S. Cl. CPC B42D 25/333; B42D 25/45; B42D 25/351; B42D 25/29; B42D 25/346

(57) ABSTRACT

Improvements in security substrates that are used in the production of security documents are provided. The security substrate includes a base substrate having a plurality of openings extending through a thickness of the base substrate. The plurality of openings define a frame of the base substrate with an island of the base substrate lying within the frame. The island is connected to the frame by a plurality of spurs formed from the base substrate, with the spurs being spaced around a periphery of the island and being separated by the plurality of openings. The frame has an inner periphery, where at least 50% of the inner periphery lies adjacent to the plurality of openings.

### CROSS REFERENCE TO RELATED APPLICATIONS

This application is a U.S. National Stage Application under 35 U.S.C. § 371 of International Application No. PCT/GB2016/050953 filed on 4 Apr. 2016, which claims the benefit of Great British Application No. GB1506990.0 filed on 24 Apr. 2015, the entire contents of both of which are incorporated herein by reference.

### BACKGROUND OF THE INVENTION

### 1. Field of the Invention

The invention relates to improvements in security substrates which are used in the production of security documents.

### 2. Description of Related Art

Security documents, such as banknotes, passports, identification cards, certificates and the like, are vulnerable to copying or counterfeiting. The increasing availability of colour photocopiers, electronic scanning and other imaging systems, and the improving technical quality of colour photocopiers, has led to an increase in the counterfeiting of such documentation. There is, therefore, a need to continually improve the security features of such documentation to add additional security features or to enhance the perceptions and resistance of simulation to existing features.

Security features generally fall in two categories, overt and covert. Overt security features are ideally easily recognisable to the person in the street without the need for an additional device, whilst being difficult to counterfeit or simulate. Covert security features are generally not made public and are preferably only detectable with the aid of special devices, such as automatic cash and note handling machines. Modern banknotes contain a range of these features, with an even higher-level security feature reserved exclusively for the issuing authority.

One well known overt security feature comprises a through hole in the security document. One example is described in US-A-2009/0236061, which relates to a security document which has an opening which has characteristic irregularities around the perimeter of the opening. Another similar example is described in US-A-2005/0224203. However, it is preferable for certain types of security documents to provide a security feature which not only provides deterrence to counterfeiters, but which is also attractive.

US-A-2002/0030360 and US-A-2008/0036197 describe security documents which have an opening which is closed with a cover foil which has a transparent foil which is provided with other security features which are visible through the hole. However the use of such a foil can be expensive according to the type of security features applied to the foil. Furthermore it can be difficult to locate the foil on the paper substrate so that the security features is visible through the hole.

### SUMMARY

It is an object of the present invention to provide an alternative security substrate which has similar advantages to the known security substrates with through holes, and which can be made to have aesthetic qualities and is not expensive to produce.

According to the present invention there is therefore provided a security substrate comprising a base substrate having a plurality of openings extending through a thickness of the substrate, said openings defining a frame of said substrate and at least one island of said substrate lying within the frame, said island being connected to the frame by a plurality of spurs formed from said substrate, said spurs being spaced around a periphery of said at least one island and being separated by the openings, wherein at least 50% of an inner periphery of the frame lies adjacent to openings.

Preferably a perimeter of the island has a different shape to that of the surrounding frame.

At least 70% of an inner periphery of the frame lies adjacent to openings and more preferably substantially 80% of an inner periphery of the frame lies adjacent to openings.

The security substrate preferably further comprises a cover layer applied to at least a part of one or both surfaces of the base substrate covering at least the frame, openings and island(s).

A further cover layer is preferably applied to at least a part of an opposing surface of the base substrate covering at least the frame and island(s) and having openings there through which are registered to the openings in the substrate.

The, one or both cover layers preferably comprise an at least partially light transmitting layer.

The, one or both cover layers are preferably provided with one or more security features.

The, one or both cover layers may be coloured and may be coloured with a plurality of colours.

Preferably each cover layer is of a different colour.

The, one or both cover layers preferably have different coloured regions which are registered with respect to the openings.

The at least one island may have a geometric shape or image.

The at least one island is preferably provided with an area of variable or reduced thickness.

Preferably the area of variable or reduced thickness is a watermark.

Preferably the area of reduced thickness is a further opening.

The area of variable or reduced thickness is preferably in the form of indicia, a geometric shape, an image or other information.

The invention further provides a security document made from the aforementioned security.

The security document preferably comprises a banknote, passport, bond, certificate, voucher or other document of value.

The invention further provides method of manufacturing the aforementioned security substrate comprising the steps of forming, in a base substrate, a plurality of openings extending through a thickness of the substrate, said openings defining a frame of said substrate and at least one island of said substrate lying within the frame, said island being connected to the frame by a plurality of spurs formed from said substrate, said spurs being spaced around a periphery of said at least on island and being separated by the openings, wherein at least 50% of an inner periphery of the frame lies adjacent to openings.

The method preferably further comprises the step of applying a cover layer to one surface of the base substrate covering at least the frame, openings and island(s).

The method preferably further comprises the step of applying a further cover layer to at least a part of an opposing surface of the base substrate before the step of forming the openings, wherein said openings are simultaneously formed in the base substrate and the further cover layer.

### BRIEF DESCRIPTION OF THE DRAWINGS

Preferred embodiments of the present invention will now be described, by way of example only, with reference to the accompanying drawings in which:—

FIGS. 1a to 1c are cross sectional side elevations illustrating the steps of forming a first embodiment of the security substrate of the present invention;

FIGS. 2a to 2d are cross sectional side elevations illustrating the steps of manufacturing a second embodiment of the security substrate of the present invention

FIGS. 3 and 4 are plan views of the security substrate of the present invention; and

FIGS. 5 to 7 are plan views of a security document made from the security substrate of the present invention.

### DETAILED DESCRIPTION

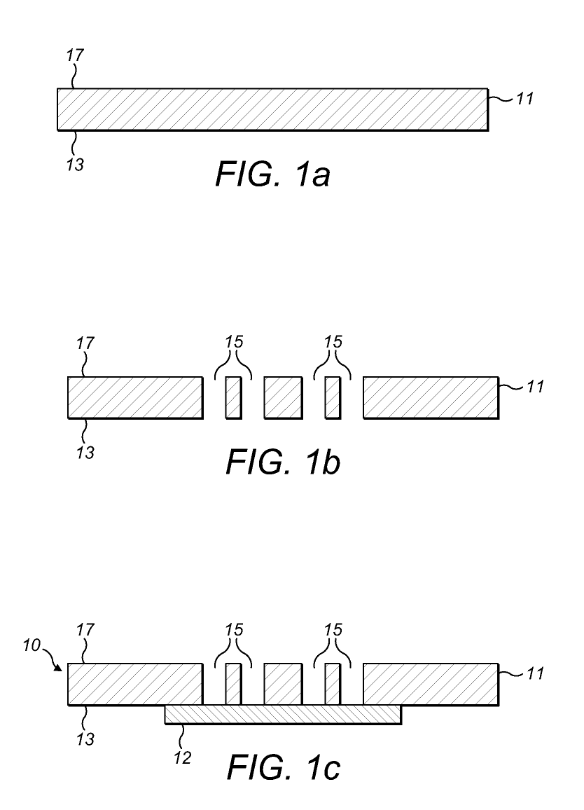

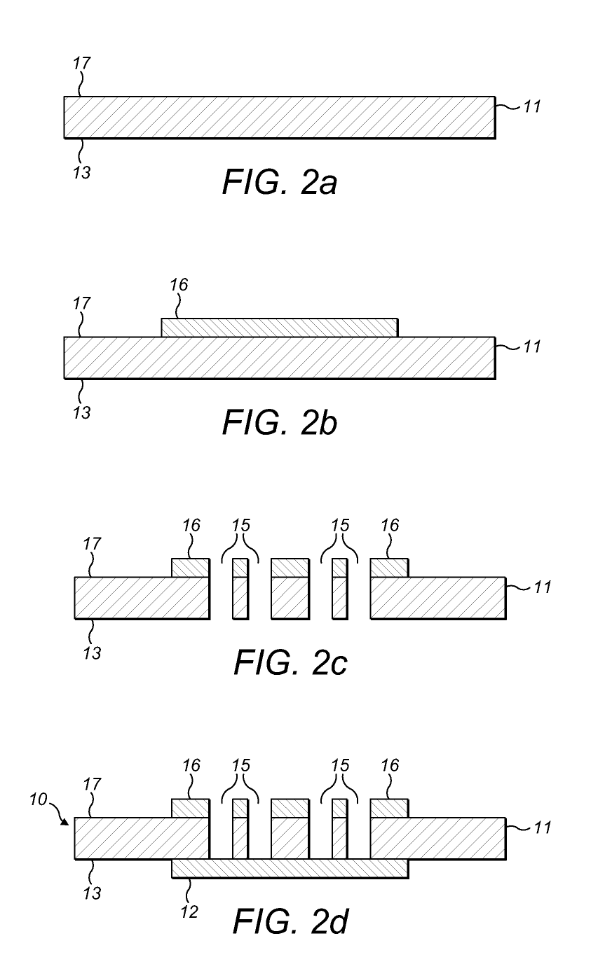

The security substrate 10 of the present invention has a security feature which has a visual and tactile impression, which is difficult to counterfeit. As shown in FIG. 1a to 1c, the security substrate 10 of the present invention is formed from a layer 11 of a base substrate. For banknote applications, the preferred thickness of the base substrate for banknote applications is between 50 and 200 microns and more preferably between 70 and 150 microns. For passports, the preferred thickness of the base substrate is likely to increase up to 200 microns. For cards, such as identity cards, the preferred thickness may be as high as 750 microns.

The base substrate may be a fibrous substrate, such as paper. A range of fibre types can be used in the making of such substrates, including synthetic or natural fibres or a mixture of both. The actual preparation of the fibres is unrestricted by the invention, and will depend on what effect it is wished to produce in the finished substrate. Alternatively the base substrate may be a non-fibrous substrate, such as a polymer substrate. For example it could be a BOPP (bi-axially oriented polypropylene) substrate coated with opacifying layers with a hole punched in the polymer substrate and then subsequently covered with the film elements).

The base substrate layer 11 may be initially manufactured in the form of a continuous web, which can be made by hand or using a known papermaking machine, such as a cylinder mould or Fourdrinier machine, or by another suitable process. The web is subsequently cut to form smaller individual sheets 14. The sheets 14 are used to form security documents such as banknotes, passports identification cards and the like. The method described herein may be applied to a web of the base substrate layer 11 or the sheets 14.

The security feature is formed by removing parts of the base substrate layer 11 by a suitable material removal process, for example punching, stamping, die-cutting or laser removal, leaving a plurality of openings 15 which extend through the thickness of the base substrate layer 11.

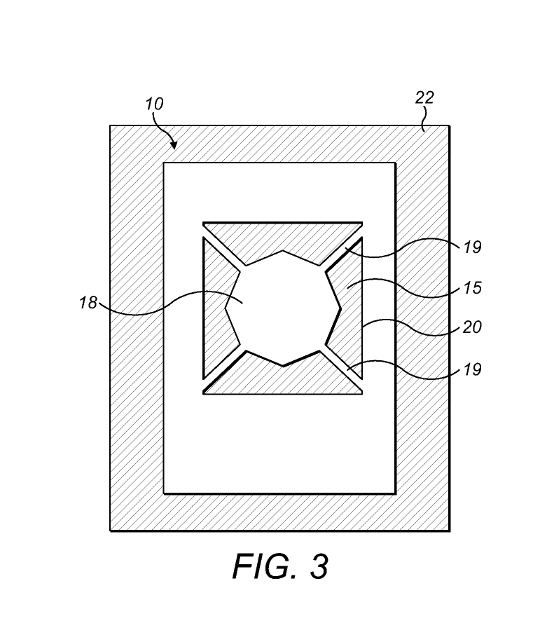

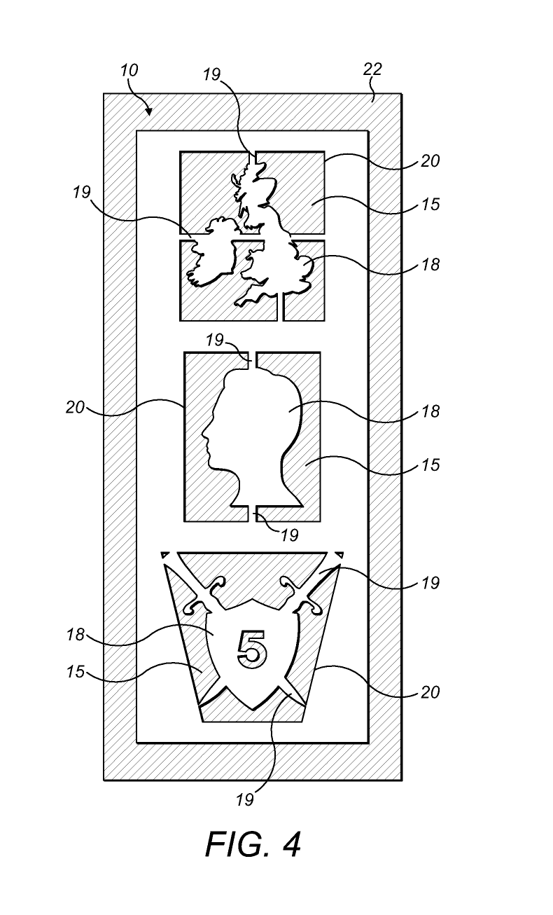

The outermost edges of the openings 15 define a frame 20 within the remaining security substrate 10 and at least one island 18 (formed from some of the remaining security substrate 10) which lies within the frame 20. The island 18 is connected to the frame 20 by a plurality of spurs 19 (formed from the remaining security substrate 10) which are spaced around the perimeter of the island 18, the spurs 19 being separated by some of the openings 15. This can be seen clearly in FIG. 3, in which the security substrate 10 is illustrated over a shaded background 22 (the latter of which does not form part of the invention but is merely used to highlight the openings 15 within the security feature). In this embodiment the island 18 is in the shape of an octagon. FIG. 4 shows three different security features, in the uppermost of which the island 18 is in the shape of a map; in the middle of which the island is in the shape of a head; and in the lowermost of which the island 18 is in the shape of a shield.

At least 50% of the inner periphery of the frame 20 lies adjacent to openings 15 (i.e. is not connected to the spurs 19). Preferably at least 70% of the inner periphery of the frame 20 lies adjacent to openings 15 and more preferably substantially 80%. The higher the percentage, the more clearly the island 18 stands out and is highlighted by the frame 20. To express this in another way no more than 50% of the perimeter of the island 18 is connected to the spurs 19, more preferably no more than 25%, and even more preferably no more than 10% to ensure the optical effect of a paper island.

Preferably each spur 19 is connected to the island 18 and not simply connected to either side of the frame 20. The openings 15 extend through the base substrate layer 11 and are not filled in with any other material. This makes the island(s) 18 stand out clearly within the surrounding frame 20.

The perimeter of the island 18 preferably has a different shape to (i.e. have the same contour or profile as) that of the surrounding frame 20. For example in FIG. 3 the frame 20 has a square profile and the perimeter of the island 18 has an octagonal profile. Likewise the same is true for the examples in the remainder of the Figures. The requirement that the perimeter of the island 18 has a different shape to that of the frame 20 increases the complexity of the security device making it more difficult to be counterfeited.

A cover layer 12 is then applied to a first surface 13 of the base substrate layer 11 covering at least the frame 20, openings 15 and island(s) 18. The cover layer 12 is preferably an at least partially light transmitting (transparent or translucent) layer, which is preferably a film or a foil, which is adhered to the base substrate layer 11 by a suitable adhesive, such as a hot melt adhesive. The definition of translucent in this context is permitting light to pass through but diffusing it so that persons, objects etc. on the opposite side can be perceived but are not clearly visible, e.g. frosted window glass is translucent but not transparent.

The thickness of the cover layer 12 is preferably 5-30 microns, and more preferably 15-25 microns. The cover layer 12 could be applied via a transfer mechanism from a carrier substrate or just applied using a suitable adhesive. It is also preferred that the cover layer 12 prevent moisture ingress to the paper where there is a seal. The preferred cover material is a polymer film, preferably polyethyleneteraphthalate (PET), polypropylene (PP), orientated polypropylene (OPP), biaxially orientated polypropylene (BOPP), polyethylene, polyamide, polycarbonate, or polyethylene naphthalate (PEN).

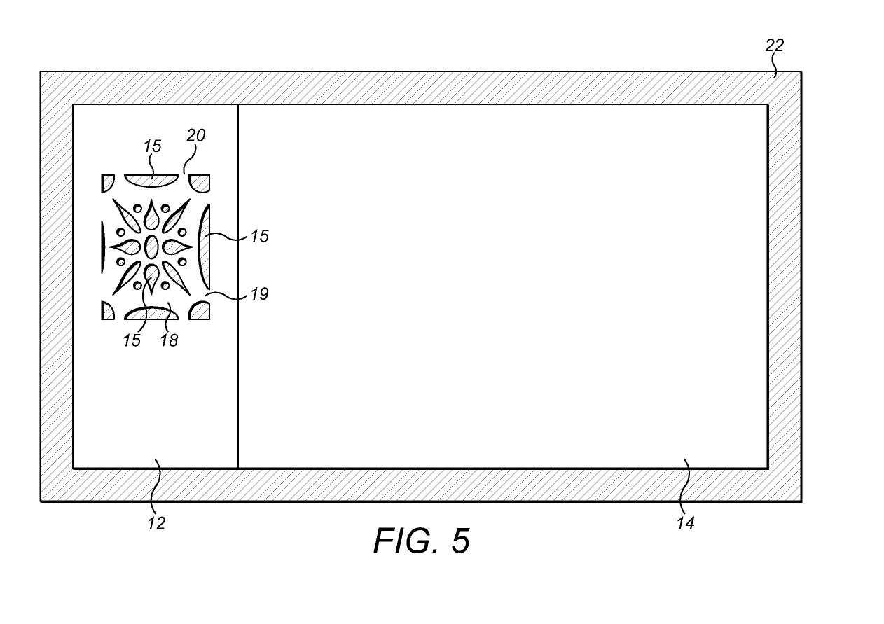

In a sheet 14 made from the security substrate 10 of the present invention, the cover layer 12 preferably does not cover the entire surface of the sheet 14. Preferably the cover layer 12 is in the form of an elongate strip, which may extend from one edge of the security document 14 to the other as shown in FIGS. 5 to 7. Alternatively the cover layer 12 is in the form of a discrete patch. The cover layer 12 gives strength to the spurs 19 and protects the surface of the security substrate 10 from soiling.

In an alternative embodiment of the invention (not illustrated), an uninterrupted cover layer 12 is applied to each surface 13,17 of the base substrate layer 11 after the openings 15 have been formed. As before, the openings 15 still extend through the base substrate layer 11 and are not filled in with any other material.

The island 18 may incorporate an area of variable or reduced thickness, such as one or more further openings 15 or a watermark 21.

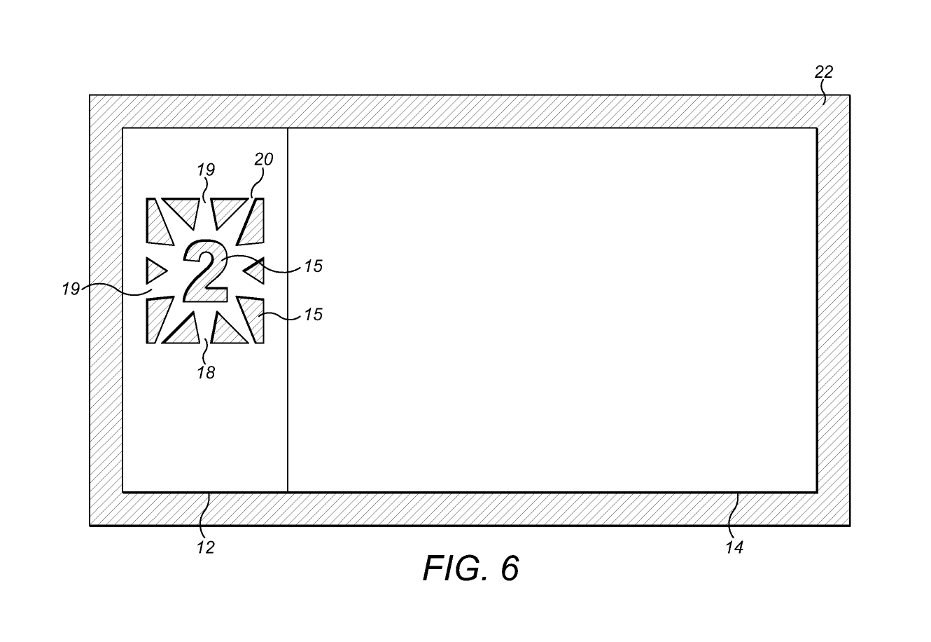

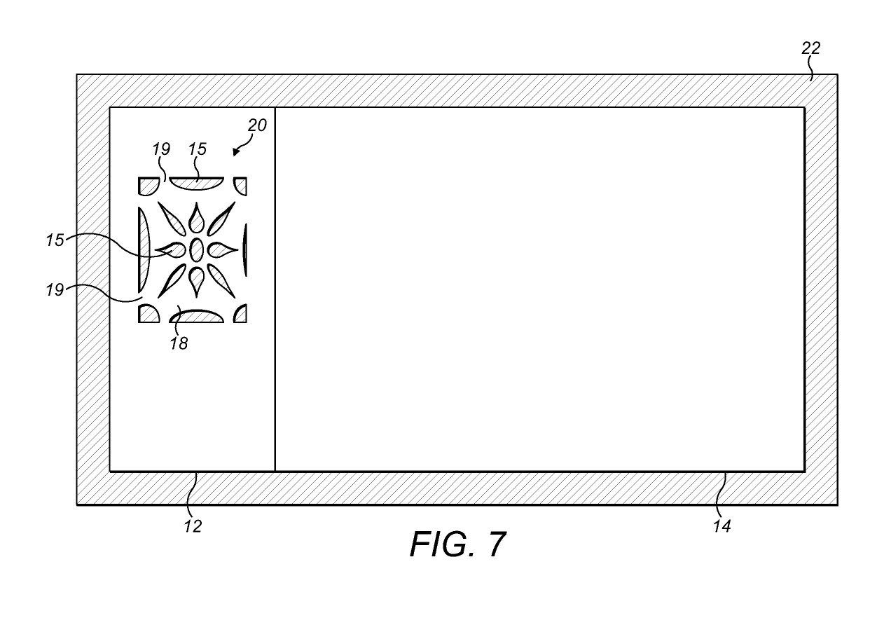

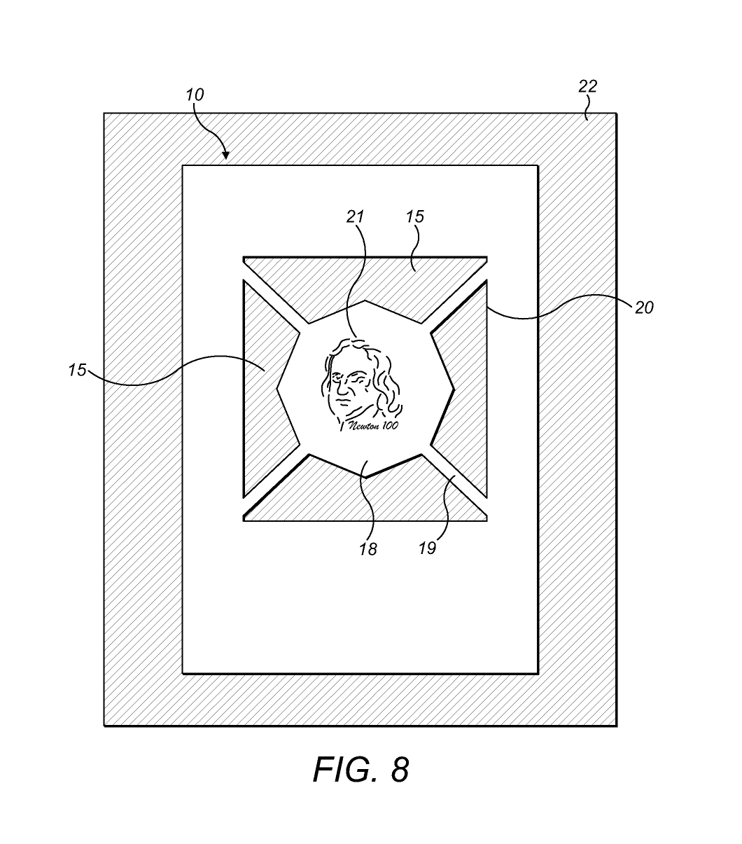

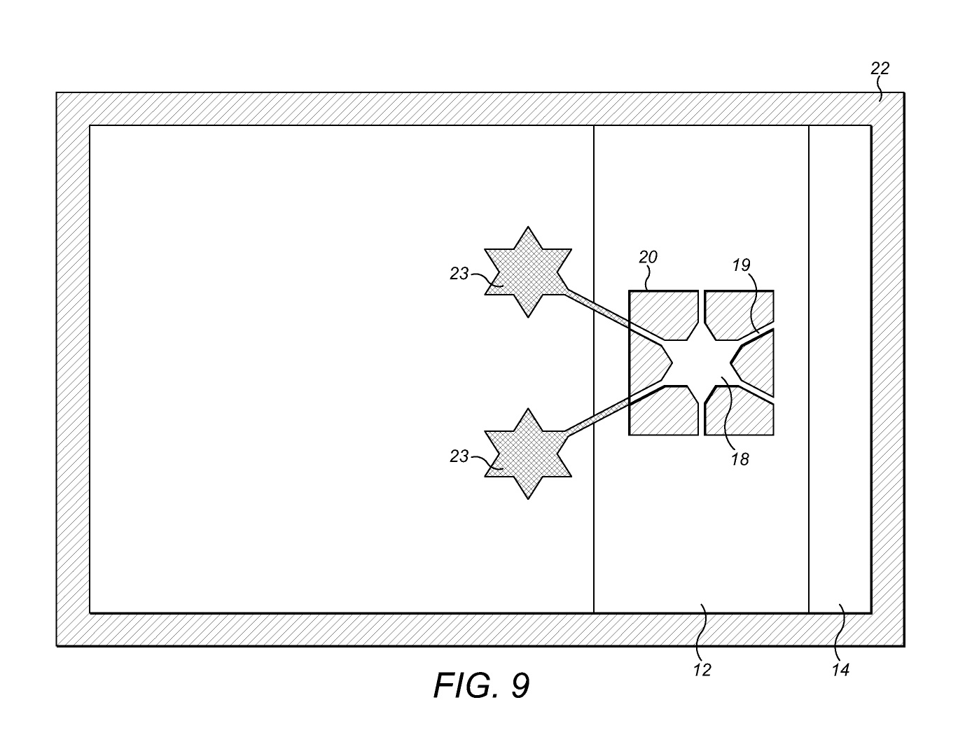

One or more other openings 15 may be designed to provide an image within the island 18 (see FIGS. 5 and 7) or information (such as the number 5 in the lowermost security feature illustrated in FIG. 4 or the number 2 in FIG. 6) or any other indicia or information. Alternatively, or in addition, the island 18 may be designed to provide a recognisable pattern or shape (such as the star shape in FIG. 6). Preferably at least one opening 15 is provided within the island 20.

A typical watermark 21 is created by well-known techniques of varying the grammage of fibres. In a cylinder mould watermark 21 there are typically some areas in which there is a higher grammage of fibres than the mean grammage in the base substrate layer, and others in which there is a lower grammage. When viewed in transmitted light the areas of lower grammage are lighter and the areas of higher grammage are darker than the base substrate, and the contrast between the light and dark areas can be very clearly seen. Some watermarks 21 may have only areas of lower grammage. Electrotypes are typically used for forming such watermarks 21. A suitable watermark 21 used in the present invention preferably has at least one area of lower grammage which provides an area of reduced thickness so that the island 18 thus has at least one area of reduced thickness. Alternatively the watermark 21 is formed so as to provide an area of varying thickness across the watermark 21. FIG. 8 illustrates a security substrate 10 with a watermark 21 located on the island 18.

The finished security substrate 10 therefore has a security feature which gives a strong visible impression in terms of the design of the island 18 and the openings 15. It has a further advantage in that it provides a tactile impression, in that the presence of the elements of the island 18 and of the openings 15 is detectable by touch and gives a rough feel to the area of second surface 17 within the frame 20. The first surface 13 of the security substrate 10 feels smooth in comparison, as the cover layer 12 is uninterrupted. Furthermore the cover layer 12 is visible through the openings 15 when the first surface 13 of the security substrate 10 is viewed.

A second cover layer 16 is optionally applied (this is the preferred embodiment) to an opposing second surface 17 of the base substrate layer 11 before the material removal process is carried out. Parts of the second cover layer 16 are therefore removed simultaneously with parts of the base substrate 11. The second cover layer 16 is preferably of the same or a similar material to that of the first cover layer 12 and has similar mechanical properties. This is so that the mechanical effects of the cover layers 12,16 on the opposing surfaces 13,17 of the security substrate 10 balance each other out, whilst enhancing the tactile effect described above. The second cover layer 16 is preferably 4-20 microns and more preferably 6-12 microns.

Alternatively the second cover layer 16 may be a lacquer layer. The lacquer may be curable by UV radiation or it may be physically drying lacquer, and may be water or solvent based. For a physically drying lacquer the binder may comprise any one or more selected from the group comprising nitrocellulose, ethyl cellulose, cellulose acetate, cellulose acetate propionate (CAP), cellulose acetate butyrate (CAB), alcohol soluble propionate (ASP), vinyl chloride, vinyl acetate copolymers, vinyl acetate, vinyl, acrylic, polyurethane, polyamide, rosin ester, hydrocarbon, aldehyde, ketone, urethane, polyethyleneteraphthalate, terpene phenol, polyolefin, silicone, cellulose, polyamide and rosin ester resins.

The lacquer composition may additionally comprise a solvent. The solvent used may comprise any one or more of an ester, such as n-propyl acetate, iso-propyl acetate, ethyl acetate, butyl acetate; an alcohol such as ethyl alcohol, industrial methylated spirits, isopropyl alcohol or normal propyl alcohol; a ketone, such as methyl ethyl ketone or acetone; an aromatic hydrocarbon, such as toluene; or water.

For a UV curable lacquer the binder may comprise an acrylic based UV curable clear embossable lacquer or coating. Such UV curable lacquers can be obtained from various manufacturers, including Kingfisher Ink Limited, product ultraviolet type UVF-203 or similar. Other suitable materials for the binder include UV curable polymers employing free radical or cationic UV polymerisation. Examples of free radical systems include photo-crosslinkable acrylate-methacrylate or aromatic vinyl oligomeric resins. Examples of cationic systems include cycloaliphatic epoxides. Hybrid polymer systems can also be employed combining both free radical and cationic UV polymerization.

The addition of the second cover layer 16 enhances the tactile effect of the security feature and provides additional strength to the spurs 19.

This security effect can be enhanced by providing the cover layer 12 with one or more additional security features, such as optically variable security features such as holograms, diffraction gratings, micro-optical structures (such as those comprising microlenses and microprisms), angular dependent coloured reflection generated from materials such as liquid crystal materials, thin film interference structures, multilayer polymeric structures and photonic crystal structures; thermochromic security features; fluorescent, luminescent or phosphorescent security features; magnetic inks; conductive metallic features; security features which have different appearances in transmissive and reflective light such as demetallised indicia. All these features will be familiar to those skilled in the art and they are also widely discussed in many publications, including many published patent specifications. The second cover layer 16 may also be provided with the same or different security features as the cover layer 12.

One or both cover layers 12,16 may be coloured, with one or more colours. The cover layer 12 may have discrete differently coloured regions which are registered with respect to the openings 15, thereby giving an effect similar to a stained glass window. The first or second cover layer may be coloured by a dye or pigment. In a particularly preferred example a registered coloured coating is applied to the first cover layer using any standard printing technique such as gravure, screen flexo or lithographic printing, such that the colour is in register with the gaps openings to produce the effect of a stained glass window in particular when viewed from the side of the document opposite the first cover film. Different colours could be provided in register with different gaps to produce a multi-colour stained window effect.

The security effect can be enhanced further by registering the design of the island, spurs and/or the openings to further features on or in the security substrate. One example of a further feature would be an additional watermark and in a preferred embodiment the island, spurs and or gaps cooperates with a watermark to form a further image. For example a further watermark, which could represent the same or related image as the island could be registered with the spurs as shown in FIG. 9. In FIG. 9 the whole of the island 18, which has a star shape and additional watermarks 23 are provided on the sheet 14, which have the same configuration or are somehow linked. In FIG. 9 the additional watermarks 23 are star shaped. The island 18 may optionally be provided with a watermark. In particular the shape of the island when combined with watermark could reveal a composite image (resulting from the island and the watermark) when the document is viewed in transmitted light which is not readily discernible in transmitted light due to the watermark being a feature only observable in transmitted light.

The design of the island, spurs and/or the openings to can be registered to printed or surface applied features on either the security substrate or one of the two cover films. For example the design of the island could be registered to holographic images on the first cover layer or printed images on the first cover layer.

The registered features in the examples above are preferably the same as, or related in context to each other. For example one feature may comprise a portrait of Sir Isaac Newton and the other feature for example the island may form the silhouette of an apple. Other shapes related in context could include an emblem or geographical outline of a country and the letters indicating its currency; the nature of a currency and numerals indicating its value; the geographical outline of a country and images from its flag, e.g. Ghana and star, Sri Lanka and lion with sword, Pakistan and crescent moon; portraits and quotations, e.g. Churchill and the phrase “fight them on the beaches”, extract, Lincoln and extract from the Gettysburg address, Washington or Franklin and declaration of independence. Jane Austen and quill pen.

The shape of the island may be a symbol, a pictorial image, an alphanumeric or a geometric or non-geometric shape.

The security substrates 10 of the present invention have a wide variety of applications, particularly as security documents such as banknotes, passports, bonds, certificates, vouchers or other documents of value.

1-22. (canceled)

23. A security substrate comprising a base substrate having a plurality of openings extending through a thickness of the base substrate, the plurality of openings defining a frame of the base substrate and at least one island of the base substrate lying within the frame, the island being connected to the frame by a plurality of spurs formed from the base substrate, the spurs being spaced around a periphery of the at least one island and being separated by the plurality of openings, wherein at least 50% of an inner periphery of the frame lies adjacent to the plurality of openings.

24. The security substrate as claimed in claim 23, wherein the island has a perimeter of with a different shape to the inner periphery of the frame.

25. The security substrate as claimed in claim 23, wherein at least 70% of the inner periphery of the frame lies adjacent to the plurality of openings.

26. The security substrate as claimed in claim 23, wherein 80% of the inner periphery of the frame lies adjacent to the plurality of openings.

27. The security substrate as claimed in claim 23, further comprising:
a first cover layer applied to at least a part of a surface of the base substrate, the first cover layer covering at least the frame, the plurality of openings, and the at least one island; or
the first cover layer together with a second cover layer applied to at least a part of an opposite surface of the base substrate, the second cover layer covering at least the frame, the plurality of openings, and the at least one island.

28. The security substrate as claimed in claim 23, further comprising:
a first cover layer applied to at least a part of a surface of the base substrate covering at least the frame and the at least one island, the first covering layer having first openings there through that are registered to the plurality of openings in the base substrate; or
the first cover layer together with and a second cover layer applied to at least a part of an opposite surface of the base substrate covering at least the frame and the at least one island, the second covering layer having second openings there through that are registered to the plurality of openings in the base substrate.

29. The security substrate as claimed in claim 27, wherein the first and/or second cover layers comprise an at least partially light transmitting layer.

30. The security substrate as claimed in claim 27, wherein the first and/or second cover layers are provided with one or more security features.

31. The security substrate as claimed in claim 27, wherein the first and/or second cover layers are colored.

32. The security substrate as claimed in claim 27, wherein the first and/or second cover layers are colored with a plurality of colors.

33. The security substrate as claimed in claim 28, wherein the first and second cover layers are of a different color.

34. The security substrate as claimed in claim 32, wherein the first and/or second cover layers have a different colored region that are registered with respect to the plurality of openings in the base substrate.

35. A security substrate as claimed in claim 23, wherein the at least one island has a geometric shape or image.

36. The security substrate as claimed in claim 23, wherein the at least one island is provided with an area of variable or reduced thickness.

37. The security substrate as claimed in claim 36, wherein the area of variable or reduced thickness is a watermark.

38. The security substrate as claimed in claim 36, wherein the area of reduced thickness is a further opening.

39. The security substrate as claimed in claim 36, wherein the area of variable or reduced thickness is in the form of indicia, a geometric shape, an image, or information.

40. A security document made from the security substrate of claim 23.

41. The security document as claimed in claim 40, wherein the security document is selected from the group consisting of a banknote, a passport, a bond, a certificate, a voucher, and a document of value.

42. A method of manufacturing a security substrate, comprising the steps of:
forming, in a base substrate, a plurality of openings extending through a thickness of the base substrate, the plurality of openings defining a frame of the base substrate and at least one island of the base substrate lying within the frame, the at least one island being connected to the frame by a plurality of spurs formed from the base substrate, the plurality of spurs being spaced around a periphery of the at least one island and being separated by the plurality of openings, wherein at least 50% of an inner periphery of the frame lies adjacent to the plurality of openings.

43. The method as claimed in claim 42, further comprising the step of:
applying a first cover layer to a surface of the base substrate covering at least the frame, the plurality of openings, and the at least one island; or
applying the first cover layer with a second cover layer to an opposite surface of the base substrate covering at least the frame, the plurality of openings, and the at least one island.

44. The method as claimed in claim 43, further comprising the step of:
applying a second cover layer to at least a part of an opposing surface of the base substrate before the step of forming the plurality of openings, wherein the plurality of openings are simultaneously formed in the base substrate and the second cover layer.

45. The security substrate as claimed in claim 28, wherein the first and/or second cover layers comprise an at least partially light transmitting layer.

46. The security substrate as claimed in claim 28, wherein the first and/or second cover layers are provided with one or more security features.

47. The security substrate as claimed in claim 29, wherein the first and/or second cover layers are provided with one or more security features.

48. The security substrate as claimed in claim 28, wherein the first and/or cover layers are colored.

49. The security substrate as claimed in claim 29, wherein the first and/or second cover layers are colored.

50. The security substrate as claimed in claim 30, wherein the first and/or second cover layers are colored.

51. The security substrate as claimed in claim 28, wherein the first and/or second cover layers are colored with a plurality of colors.

52. The security substrate as claimed in claim 29, wherein the first and/or second cover layers are colored with a plurality of colors.

53. The security substrate as claimed in claim 30, wherein the first and/or second cover layers are colored with a plurality of colors.

54. The security substrate as claimed in claim 31, wherein the first and/or second cover layers are colored with a plurality of colors.

55. The security substrate as claimed in claim 29, wherein the first and second cover layers are each of a different color.

56. The security substrate as claimed in claim 30, wherein the first and second cover layers are each of a different color.

57. The security substrate as claimed in claim 31, wherein the first and second cover layers are each of a different color.

58. The security substrate as claimed in claim 32, wherein the first and second cover layers are each of a different color.

59. The security substrate as claimed in claim 27, wherein the first and/or second cover layers have different colored regions that are registered with respect to the plurality of openings.

60. The security substrate as claimed in claim 37, wherein the area of variable or reduced thickness is in the form of indicia, a geometric shape, an image, or information.

61. The security substrate as claimed in claim 38, wherein the area of variable or reduced thickness is in the form of indicia, a geometric shape, an image, or information.
